(19) United States
(12) Patent Application Publication
(10) Pub. No.: US 2012/0042781 A1
(43) Pub. Date: Feb. 23, 2012

(54) Purification Module

(75) Inventors: Bruno Berthome, Paris (FR); Sylvain Irlande, Chaumes en Brie (FR)

(73) Assignee: L'Air liquide Societe Anonyme Poue L'Etude Et L'Exploitation Des Procedes Georges Claude, Paris (FR)

(21) Appl. No.: 13/148,505

(22) PCT Filed: Feb. 20, 2009
(86) PCT No.: PCT/FR09/50272

§ 371 Date: Aug. 9, 2011

(51) Int. Cl. B01D 53/02

(52) U.S. Cl. 96/126

(57) ABSTRACT

The invention relates to a device for purification by adsorption of a gas, including at least one adsorber (1), at least one set of pipes (4) and at least one set of supports (7), characterized in that said adsorber (1) is suitable for supporting the set of supports (7) and the set of pipes (4).

The present invention relates to a device for purifying a gaseous mixture, of the type comprising at least two adsorbers, with a great deal of pipework fitted with valving to connect the lower and upper parts of the various adsorbers to the fluid circuits.

Separation devices of this kind are essentially used in PSA (Pressure Swing Adsorption) or TSA (Temperature Swing Adsorption) techniques for producing, from a gaseous mixture, a gaseous constituent component of this mixture, notably a constituent of the air, oxygen or nitrogen, or for purifying a gaseous mixture, notably the air fed to a cryogenic air separation unit, but also for producing a constituent of the air, oxygen and/or nitrogen and/or argon, and generally employ at least one of the adsorbents chosen from the group comprising zeolites, active charcoal, alumina, or silica gels. Examples of these technologies are described notably in the documents U.S. Pat. No. 5,223,004, EP-0,092,153, U.S. Pat. No. 3,338,030 or U.S. Pat. No. 5,137,548.

In general, the various elements and equipment of the purification module are mounted around a metallic structure with the exception of the purification cylinders and the connecting pipework. The metallic structure and the elements supported thereby constitute the “skid”.

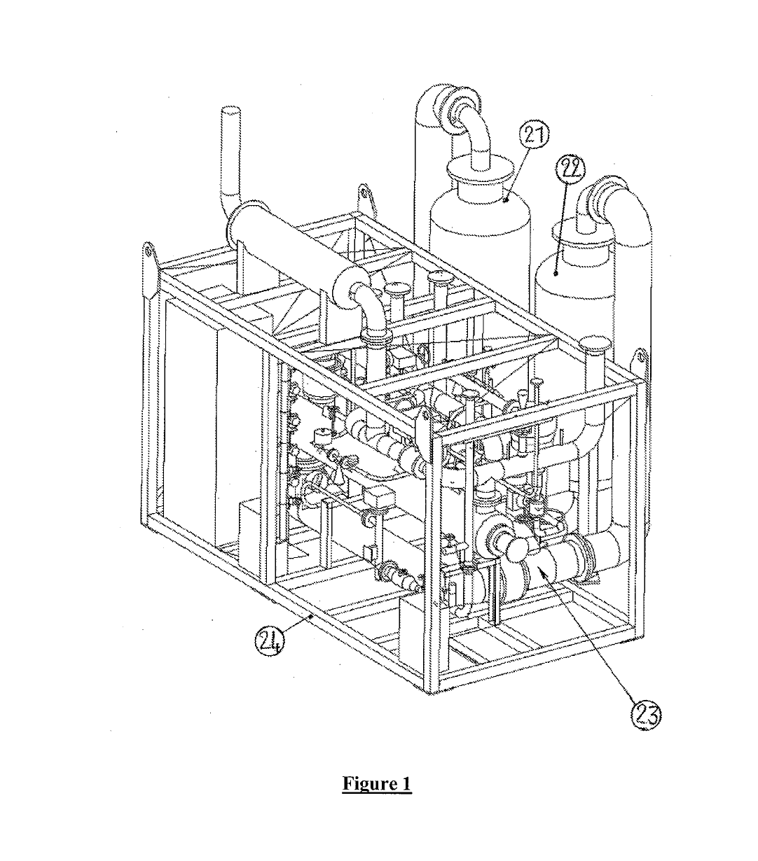

FIG. 1 depicts a purification module comprising a skid. Typically, a purification module comprises a first purification cylinder 21, a second purification cylinder 22, a skid 23 and a metallic structure 24.

However, the use of a skid makes arranging the pipework and the elements involving sheet metalwork more complicated, and imposes numerous constraints during the design, manufacture, assembly and operation phases.

During the skid design phase, the arrangement of all the set of equipment and pipework has to fit into a finite space that complies with the customary size requirements for the transport of heavy packages. This assembly constraint makes it very difficult to standardize the routing of the pipework, and to evolve and adapt the design of the skids to suit new materials or new regulations.

What is more, the use of a metallic structure as a support and to hold the set of equipments and pipework entails complex design and dimensioning calculations.

During the purification module manufacture and assembly phases, access to the equipments is difficult given the close proximity of the various elements and given the compactness of assembly of the skid. Because of that, manufacturing, handling and assembly times are longer especially when the complexity is great. Furthermore, surface treatment of all of the components requires tricky handling which leads to inevitable needs to touch up the paintwork.

During the module operating phase, replacement of hardware and routine maintenance are difficult to carry out because not all of the equipment is directly accessible. This lack of accessibility may lead to the short-term hiring of heavy handling equipment such as cranes. In addition, the lack of accessibility means that accurately connecting the purification cylinders to the skid is a tricky operation that takes a long time to achieve.

Finally, when in use, such a purification module occupies a great deal of floor space by comparison with the sizes of the purification cylinders.

All that being so, one problem which arises is that of providing a purification device the design of which can be standardized, evolved and adapted, and the equipment of which is readily accessible.

A solution of the invention is a device for purifying a gas by adsorption, comprising at least one adsorber 1, at least some pipework 4, and at least one set of supports 7, characterized in that the adsorber 1 is able to support the set of supports 7 and the set of pipework 4.

Depending on circumstance, the purification device according to the invention may have one or another of the following features:

said device comprises two adsorbers 1 and 2 able to support the set of supports 7 and the set of pipework 4;

said adsorbers support the pipework 4 directly or via the set of supports 7;

the size of the pipework ranges between 50 mm and 750 mm, preferably between 80 mm and 500 mm, and more preferably still, between 100 mm and 400 mm;

said device has an arrangement such that the device can be lifted, handled and transported in its entirety;

said device comprises lifting, handling and transport means;

at least one set of pipework comprises an additional support connected to the ground; this additional support connected to the ground is preferably used if maintenance is carried out on said pipework;

said device comprises a silencer, a heater, valves and check valves;

the heater, the silencer and the adsorbers are in a vertical position;

said adsorbers support the silencer 5 in its entirety, directly and/or via the pipework 4 and/or via the set of supports 7;

said adsorbers support the heater 6 in its entirety, directly and/or via the pipework 4 and/or via the set of supports 7;

the device comprises equipment requiring maintenance and/or manipulation located on the facade;

the device comprises an inlet 10 for gas leading to a first adsorber and an outlet 9 for gas leading from a second adsorber, said inlet and said outlet both being situated on the same side of the device.

What is meant by “size of the pipework” is the outside diameter of the pipework not taking into consideration any equipment such as valves that may be incorporated into the pipework.

What is meant by equipment which is located “on a facade” is equipment that is located so that it faces the user such that it can be readily accessed.

Equipment requiring maintenance and/or manipulation is equipment of the check valve, valve, relief valve, instrumentation, regulator, etc. type.

What is meant by a set of supports is an assembly of metal sections dimensioned by calculation, assembled and welded together in order to support the pipework and the equipment. This assembly makes it possible to limit the number of connections between the cylinder and the other parts of the purification module, to better distribute the load over the adsorbers, and make equipment maintenance easier.

Further, another subject of the present invention is the use of the purification device according to the invention, to produce air fed into a cryogenic air separation unit.

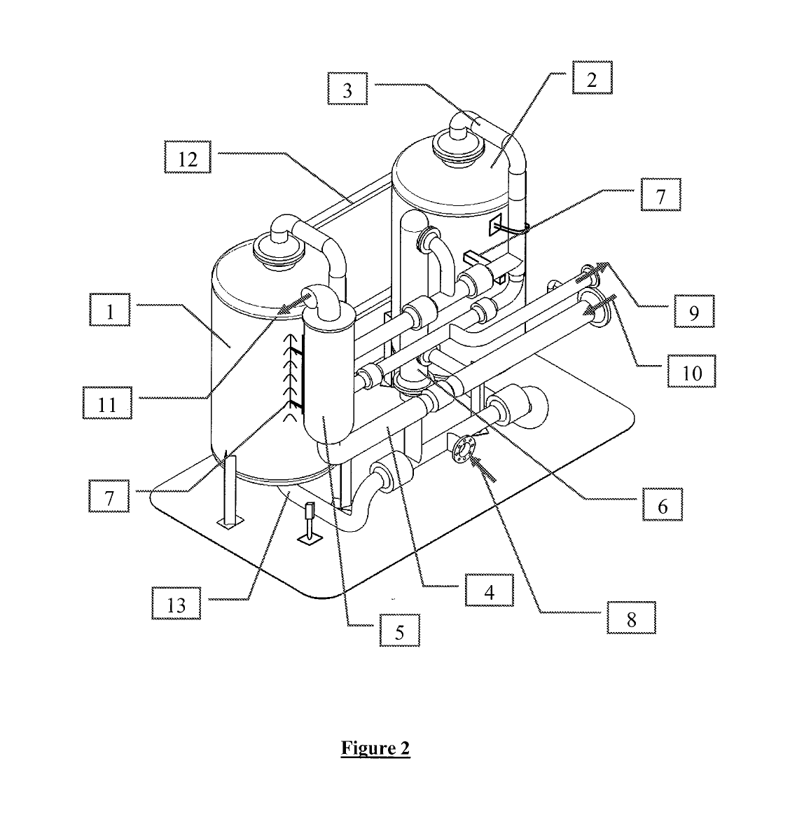

The invention will be described in greater detail by means of FIG. 2.

FIG. 2 depicts a purification device according to the invention.

In the purification device according to the invention, the metallic structure conventionally used is omitted. The first adsorber 1 and the second adsorber 2 are used as supports for the pipework 4.

The gas heater 6 used to regenerate the purification cylinders, and the silencer 5, which minimizes gas outlet noises, may be supported on the ground via fixings, by the adsorbers via dedicated welded supports 7, or by the pipework. In the case of heavy loads, “filler plates” may be placed between the adsorbers and the dedicated welded supports, in order better to distribute the forces over the adsorber. What is meant here by a “filler plate” is metal plates attached by welding to the adsorber and performing a strengthening function.

The first and second purification cylinder are of axial type with an inlet/outlet at the top 3 and an inlet/outlet at the bottom 13.

The purification module notably includes the inlets and outlets 8, 9, 10 and 11 intended for horizontal connection.

In order to be transportable from its design site to its operating site, the purification device may comprise a number of removal reinforcing bars 12 which connect the cylinders.

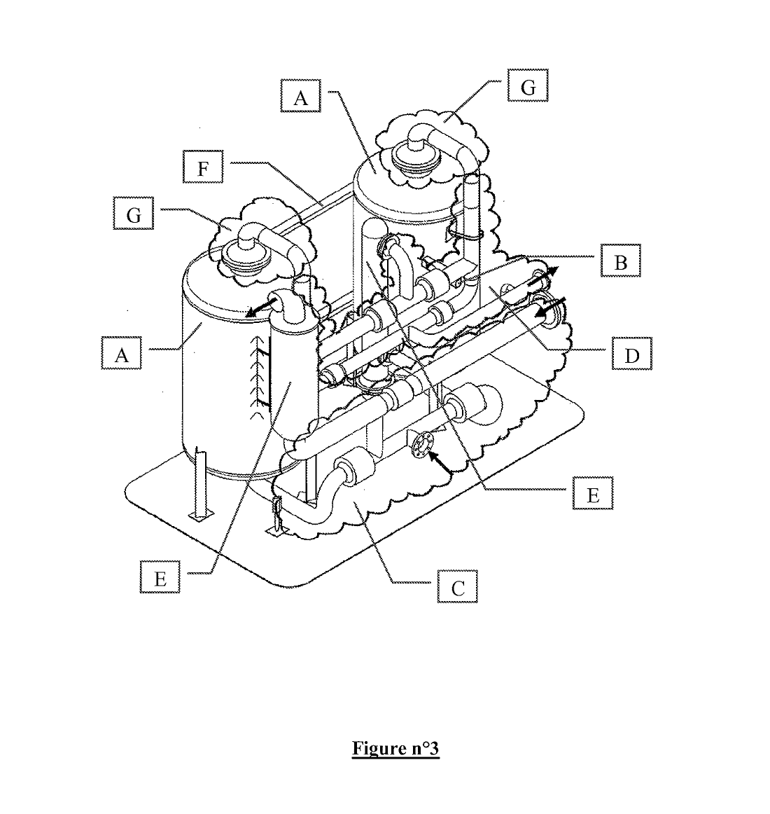

FIG. 3 illustrates one assembly of the purification device according to the invention.

Specifically, one of the mounting methods may comprise the following steps:

step one: positioning vertical adsorbers on legs (reference A);

step two: attaching the set of pipework supports (reference B);

step three: mounting the pipework in the bottom portion of the purification module (reference C);

step four: mounting the pipework in the upper portion of the purification module (reference D);

step five: mounting the equipments (heater, silencer, electrical cabinets, electricity, instrumentation) (reference E);

step six: filling the cylinders;

step seven: lagging the pipework;

step eight: fitting the lifting bars (reference F).

The pipework reference G will be mounted at the production site.

The purification device according to the invention allows a reduction in the cost of manufacture, minimizes the development time for new work involving a purification device, and affords better flexibility in adapting to suit new materials and/or new regulations.

From a cost standpoint, the overall mass of all the pipework has been reduced by around 30%, the number of welds and lengths of piping minimized. The omission of the metallic framework allows a saving on the purchase cost, design cost and calculation expenses. Finally, better awareness of the costs of the purification device allows for better control over the expenditure incurred.

Standardizing the purification device simplifies the understanding of methods and reduces the number of components.

Further, the purification device according to the invention can be adapted to suit the various regulations and building codes in the countries across the world.

The purification device according to the invention also makes it possible significantly to reduce the installation times currently experienced with a purification device comprising a skid. Specifically, there is no longer any connection to be made between the cylinder of the skid: the purification device according to the invention is a prebuilt subassembly ready to be connected up. Access to equipment for maintenance makes on-site interventions easier. All the valves, check valves and pipework elements are aligned on the facade in order to minimize manipulation and associated risks. In a purification device comprising a skid, the time taken to replace a check valve may be in excess of one day because of access difficulties. With the device according to the invention, this replacement time can be brought down to just a few hours.

Finally, as may be seen from FIG. 2, the purification device according to the invention occupies less floor space than a device comprising a skid would occupy. Specifically, the floor space and civil engineering slab work required to install all of the equipments is reduced of the order of 80% of the floor space needed for installing a skid-mounted equivalent.

By way of example, when installing a gas production unit capable of processing an air flow rate of 5000 Nm³/h, the area of civil engineering slab work used to install the purification skid and its adsorbers, of a diameter of about 1.5 m, covers a total of 30 m². With the new purification module and according to the invention, the area required is now just 20 m², all the other equipments being of similar size or of a size that remains unchanged.

1-14. (canceled)

15. A device for purifying a gas by adsorption, the device comprising two adsorbers (1) and (2), at least some pipework (4), a silencer (5), a heater (6) and at least one set of supports (7), in which the two adsorbers (1) and (2) support the set of supports (7), the set of pipework (4) and the silencer (5) and the heater (6) in their entirety, directly and/or via the pipework (4) and/or via the set of supports (7).

16. The device of claim 15, wherein the adsorbers (1) and (2) support the pipework (4) directly or via the set of supports (7).

17. The device of claim 15, wherein the size of the pipework ranges between 50 mm and 750 mm.

18. The device of claim 17, wherein the size of the pipework ranges between 80 mm and 500 mm.

19. The device of claim 18, wherein the size of the pipework ranges between 100 mm and 400 mm.

20. The device of claim 15, wherein the device has an arrangement such that the device can be lifted, handled and transported in its entirety.

21. The device of claim 15, wherein the device further comprises lifting, handling and transport means.

22. The device of claim 15, wherein the device comprises a silencer, a heater, valves and check valves.

23. The device of claim 15, wherein the heater, the silencer and the adsorbers are in a vertical position.

24. The device of claim 15, wherein the device comprises equipment requiring maintenance and/or manipulation located on the facade.

25. The device of claim 15, wherein the device comprises an inlet (10) for gas leading to a first adsorber and an outlet (9) for gas leading from a second adsorber, the inlet and the outlet both being situated on the same side of the device.

26. The device of claim 16, wherein the size of the pipework ranges between 50 mm and 750 mm.

27. The device of claim 26, wherein the device has an arrangement such that the device can be lifted, handled and transported in its entirety.

28. The device of claim 26, wherein the device further comprises lifting, handling and transport means.

29. The device of claim 28, wherein the device comprises a silencer, a heater, valves and check valves.

30. The device of claim 29, wherein the heater, the silencer and the adsorbers are in a vertical position.

31. The device of claim 30, wherein the device comprises an inlet (10) for gas leading to a first adsorber and an outlet (9) for gas leading from a second adsorber, the inlet and the outlet both being situated on the same side of the device.

32. The device of claim 31, wherein the device is utilized to produce air fed into a cryogenic air separation unit.

33. The device of claim 15, wherein the device is utilized to produce air fed into a cryogenic air separation unit.
